(19) United States
(12) Patent Application Publication
(10) Pub. No.: US 2013/0044201 A1
(43) Pub. Date: Feb. 21, 2013

(54) HAND-HELD FLUORESCENCE MICROSCOPE WITH PARTIAL-SPECTRUM LIGHT SOURCE

(71) Applicant: Paul Neng-Wei WU, Hsinchu City (TW)

(72) Inventor: Paul Neng-Wei WU, Hsinchu City (TW)

(73) Assignee: AnMo Electronics Corporation, Hsinchu City (TW)

(21) Appl. No.: 13/569,747

(22) Filed: Aug. 8, 2012

(30) Foreign Application Priority Data
Aug. 19, 2011 (TW) 100129714

(51) Int. Cl. H04N 7/18

(52) U.S. Cl. 348/79; 348/E07.085

(57) ABSTRACT

A hand-held fluorescence microscope is disclosed, including: a partial-spectrum light source, a first filtering device, a second filtering device, and an image sensor arranged inside a housing of the hand-held fluorescence microscope. The partial-spectrum light source generates a first light beam. The first filtering device filters the first light beam to provide a second light beam. The second filtering device filters a fluorescence generated by a specimen after receiving the second light beam to provide a fourth light beam. The image sensor receives the fourth light beam to generate fluorescence images. One end of the housing is provided with a light mask for surrounding the specimen to avoid external light from being entering the image sensor. The light path of the second light beam projecting to the specimen does not overlap with the light path of the fluorescence radiating from the specimen to the second filtering device.

### CROSS-REFERENCE TO RELATED APPLICATIONS

This application claims the benefit of priority to Taiwanese Patent Application No. 100129714, filed on Aug. 19, 2011; the entirety of which is incorporated herein by reference for all purposes.

### BACKGROUND

The present disclosure generally relates to a microscope and, more particularly, to a hand-held fluorescence microscope.

Many substances release fluorescence of a longer wavelength after absorbing light beam of a particular wavelength. Accordingly, one may determine whether there is any particular substance existing in a specimen or determine allocation of the particular substance within the specimen by detecting whether any light beam of particular wavelength is being released from the specimen. For example, when examining DNA, antibody, or other biological specimen, one may utilize a light beam of particular wavelength to shine on the specimen, and then utilize a fluorescence microscope to observe the fluorescence released from the specimen to determine whether the substance to be detected exists in the specimen.

FIG. 1 is a simplified schematic diagram of a traditional fluorescence microscope 100. The fluorescence microscope 100 comprises an excitation light source 110, an excitation filter 120, a dichroic mirror 130, an objective lens 140, an emission filter 150, and an image sensor 160. In the fluorescence microscope 100, the excitation filter 120 is utilize for filtering a light beam L11 generated by the excitation light source 110. The excitation filter 120 filters out light components of longer wavelength, and allows a light beam L12 having a wavelength less than a particular wavelength (e.g., 490 nm) to pass the excitation filter 120.

When the light beam L12 filtered by the excitation filter 120 passes to the dichroic mirror 130, the dichroic mirror 130 reflects a light beam L13 of a wavelength less than a specific value (e.g., 500 nm) to the specimen, while allows a light beam L14 of a wavelength greater than the specific value to pass therethrough and not transmit to the specimen.

The light beam L13 reflected by the dichroic mirror 130 then passes to the specimen through the objective lens 140. Once excitated by the light beam L13, the particular fluorescent dye within the specimen would release fluorescence L15 of longer wavelength. The fluorescence L15 would pass to the emission filter 150 via the objective lens 140 and the dichroic mirror 130. The emission filter 150 filters light components of shorter wavelength, and allows a light beam L16 having a wavelength less than a particular wavelength (e.g., 510 nm) to pass the emission filter 150. Then, the image sensor 160 generates fluorescence images according to the received light.

As shown in FIG. 1, the light path of the light beam L13 passing to the specimen from the fluorescence microscope 100 overlaps with the light path of the fluorescence L15 generated from the specimen. In this optical arrangement, due to the limited filtering ability of the excitation filter 120 and the emission filter 150, the reflection light of the light beam L13 from the specimen may mix in the light path of the fluorescence L15. As a result, the optical noise received by the image sensor 160 increases and thus the observation quality of the fluorescence images is reduced. In the related art, filters with extremely high filtering performance may be utilized to mitigate the above optical problem, but the hardware cost would be significantly increased, and thus is not an ideal solution.

Additionally, in the traditional fluorescence microscope 100, the excitation light source 110 is a full-spectrum light source, such as a mercury-vapor lamp or a xeon arc lamp, so the light beam L11 generated by the excitation light source 110 covers a very wide range of spectrum. Therefore, the excitation filter 120, the dichroic mirror 130, and the emission filter 150 should be implemented with components of higher performance level in order to reduce optical interference when the specimen is exposed to light components of other wavelengths. To this end, the components complexity of the fluorescence microscope 100 would be inevitably increased.

Furthermore, the traditional excitation light source 110 not only has a bulky volume, but also causes high temperature when operating. Accordingly, it requires more heat dissipation space or more complex heat dissipation mechanism to remove the heat so as to avoid peripheral components from being damaged. Thus, it is difficult to integrate the traditional excitation light source 110 with other components in the fluorescence microscope 100, and thus unable to shrink the fluorescence microscope 100 to make the fluorescence microscope 100 to become portable by the user. As a result, all specimens need to be transported or moved to the location where the fluorescence microscope 100 is placed before conducting examination. If the specimen is not possible to be prepared in a location near the fluorescence microscope 100, then the specimen must be transported with appropriate preservation mechanism. Otherwise, the detection accuracy of the specimen is easily affected due to the degradation of the fluorescent dye. As can be seen from the above, the transportation procedure of the specimen is thus a crucial factor that affects the detection result.

In general cases, the fluorescence released from the specimen is weak, so the detection operation of the fluorescence microscope 100 is easily affected by the ambient light. Hence, the traditional fluorescence microscope 100 must be operated in the dark room so that ideal observation images can be obtained.

The foregoing factors not only cause the traditional fluorescence microscope 100 to have more complex manufacturing processes, larger volume, and higher cost, but also restrict that the fluorescence microscope 100 has to operate under specific environment, such as in a dark room.

### SUMMARY

In view of the foregoing, it can be appreciated that a substantial need exists for a fluorescence microscope with simplified structure of components so as to shrink the volume of the fluorescence microscope, and capable of improving the observation quality of the fluorescence images and increasing the convenience in use.

An example embodiment of a hand-held fluorescence microscope is disclosed comprising: a housing; a first partial-spectrum light source, arranged inside the housing, for generating a first light beam; a first filtering device, arranged inside the housing, for filtering the first light beam to provide a second light beam; a second filtering device, arranged inside the housing, for filtering a fluorescence to provide a fourth light beam, wherein the fluorescence is generated by a specimen when exposed to the second light beam; an image sensor, arranged inside the housing, for receiving the fourth light beam to generate fluorescence images; and a light mask, arranged in one end of the housing, for surrounding the specimen to reduce or avoid external light from being entering the image sensor; wherein a light path of the second light beam projecting to the specimen does not overlap with a light path of the fluorescence radiating from the specimen to the second filtering device, and there is no dichroic mirror positioned on either a light path of the fluorescence into the second filtering device or a light path of the fourth light beam into the image sensor.

Another example embodiment of a hand-held fluorescence microscope is disclosed comprising: a housing; a first partial-spectrum light source, arranged inside the housing, for generating a first light beam; a first filtering device, arranged inside the housing, for filtering the first light beam to provide a second light beam; a second filtering device, arranged inside the housing, for filtering a fluorescence to provide a fourth light beam, wherein the fluorescence is generated by a specimen when exposed to the second light beam; a second partial-spectrum light source, arranged inside the housing, for generating a fifth light beam to shine on the specimen, wherein the fifth light beam and the first light beam have different light colors, the first partial-spectrum light source is turn off when the second partial-spectrum light source is turn on, and the second partial-spectrum light source is turn off when the first partial-spectrum light source is turn on; an image sensor, arranged inside the housing, for receiving the fourth light beam to generate a fluorescence image; and a light mask, arranged in one end of the housing, for surrounding the specimen to reduce or avoid external light from being entering the image sensor; wherein a light path of the second light beam projecting to the specimen does not overlap with a light path of the fluorescence radiating from the specimen to the second filtering device, and there is no dichroic mirror positioned on either a light path of the fluorescence into the second filtering device or a light path of the fourth light beam into the image sensor.

Yet another example embodiment of a hand-held fluorescence microscope is disclosed comprising: a housing; a first partial-spectrum light source, arranged inside the housing, for generating a first light beam; a first filtering device, arranged inside the housing, for filtering the first light beam to provide a second light beam; a second filtering device, arranged inside the housing, for filtering a fluorescence to provide a fourth light beam, wherein the fluorescence is generated by a specimen when exposed to the second light beam; a second partial-spectrum light source, arranged inside the housing, for generating a sixth light beam, wherein the sixth light beam and the first light beam have different light colors, the first partial-spectrum light source is turn off when the second partial-spectrum light source is turn on, and the second partial-spectrum light source is turn off when the first partial-spectrum light source is turn on; a third filtering device, arranged inside the housing, for filtering the sixth light beam to provide a seventh light beam; an image sensor, arranged inside the housing, for receiving the fourth light beam to generate a fluorescence image; and a light mask, arranged in one end of the housing, for surrounding the specimen to reduce or avoid external light from being entering the image sensor; wherein a light path of the fluorescence radiating from the specimen to the second filtering device does not overlap with either a light path of the second light beam projecting to the specimen or a light path of the seventh light beam projecting to the specimen, and there is no dichroic mirror positioned on either a light path of the fluorescence into the second filtering device or a light path of the fourth light beam into the image sensor.

It is to be understood that both the foregoing general description and the following detailed description are example and explanatory only and are not restrictive of the invention, as claimed.

### BRIEF DESCRIPTION OF THE DRAWINGS

FIG. 1 is a simplified schematic diagram of a traditional fluorescence microscope.

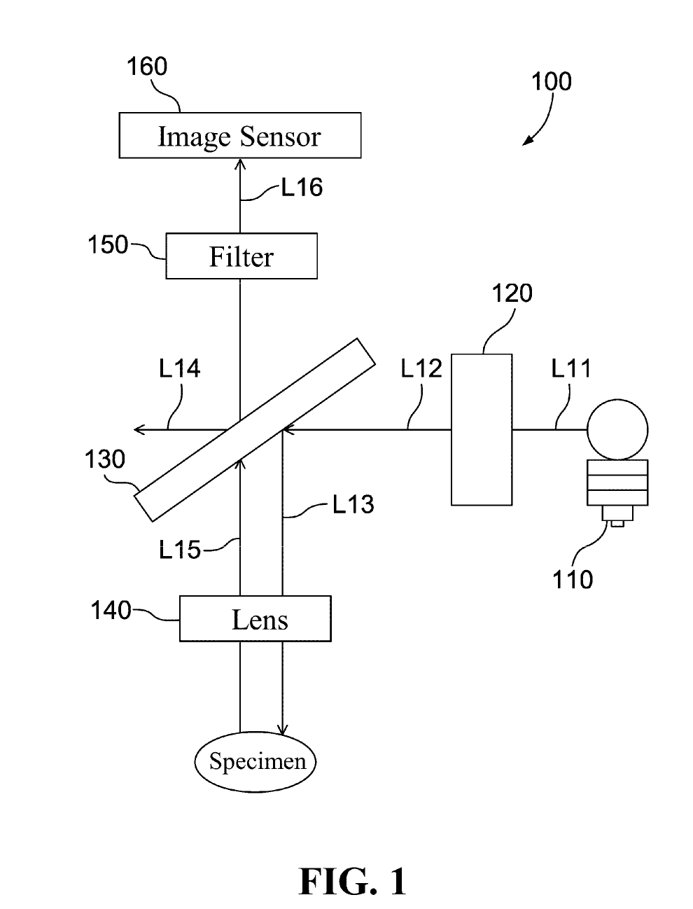

FIG. 2 is a simplified schematic diagram of a hand-held fluorescence microscope in accordance with a first example embodiment.

FIG. 3 is a simplified schematic diagram of a hand-held fluorescence microscope in accordance with a second example embodiment.

FIG. 4 is a simplified schematic diagram of a hand-held fluorescence microscope in accordance with a third example embodiment.

FIG. 5 is a simplified schematic diagram of a hand-held fluorescence microscope in accordance with a fourth example embodiment.

### DETAILED DESCRIPTION

Reference will now be made in detail to embodiments of the invention, which are illustrated in the accompanying drawings. The same reference numbers may be used throughout the drawings to refer to the same or like parts or components.

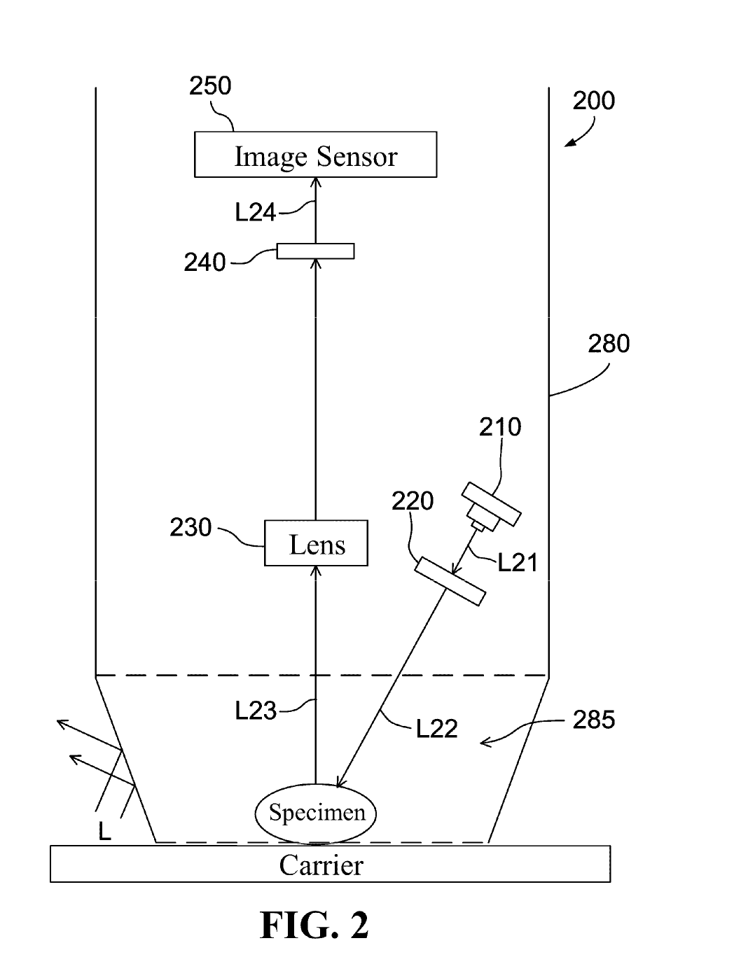

FIG. 2 is a simplified schematic diagram of a hand-held fluorescence microscope 200 in accordance with a first example embodiment. The hand-held fluorescence microscope 200 is utilized for performing fluorescence detection on a specimen placed on a carrier, such as a glass sheet or a desktop. The hand-held fluorescence microscope 200 comprises a first partial-spectrum light source 210, a first filtering device 220, an objective lens 230, a second filtering device 240, an image sensor 250, and a housing 280. In the hand-held fluorescence microscope 200, the first partial-spectrum light source 210 is implemented with a light source having a tiny volume and narrower spectrum of output light to replace the traditional full-spectrum light source, such as a mercury-vapor lamp or a xeon arc lamp. For example, the first partial-spectrum light source 210 may be one or more light emitting diodes (LEDs) or laser diodes (LDs). As a result, the required space for disposing the light source can be significantly reduced.

In comparison with the traditional full-spectrum light source, such as a mercury-vapor lamp or a xeon arc lamp, the partial-spectrum light source, such as LED or LD, not only has a much smaller volume, but also generates much less heat.

In operations, the first partial-spectrum light source 210 generates a first light beam L21 covering a narrower range of spectrum. The first filtering device 220 filters out light components having a wavelength greater than a first predetermined value (e.g., 490 nm) from the first light beam L21, and allows a second light beam L22 having a wavelength less than or equal to the first predetermined value to pass the first filtering device 220.

When the second light beam L22 outputted from the first filtering device 220 passes to the specimen, particular fluorescent dye within the specimen would be excitated and releases fluorescence L23 of a longer wavelength (e.g., 515 nm or above). In the embodiment of FIG. 2, the objective lens 230 is positioned on a light path between the specimen and the second filtering device 240. The fluorescence L23 passes to the second filtering device 240 through the objective lens 230. The second filtering device 240 filters out light components having a wavelength less than a second predetermined value (e.g., 510 nm), and allows a fourth light beam L24 having a wavelength greater than or equal to the second predetermined value to pass the second filtering device 240 and then to enter the image sensor 250.

The image sensor 250 is utilized for generating fluorescence images or conducting subsequent analysis according to the fourth light beam L24 passed through the second filtering device 240. In implementations, the image sensor 250 may be realized by one or more complementary metal oxide semiconductor (CMOS) sensors, charge coupled device (CCD) sensors, charge injection device (CID) sensors, other optical sensors, or any combination of the above components.

In addition, a light mask 285 is arranged in the front end of the housing 280 of the hand-held fluorescence microscope 200. The light mask 285 may be realized by non-transparency materials or low transparency materials. In implementations, the light mask 285 may be formed integrally, or may be assembled with multiple components. The light mask 285 is appropriately dimensioned so as to surround the specimen to avoid ambient light (e.g., the light beam L of FIG. 2) from entering into the image sensor 250 from outside of the light mask 285. In this way, the interference caused by ambient light during the examination of the specimen can be reduced or eliminated. Accordingly, the disclosed hand-held fluorescence microscope 200 is capable of successfully detecting fluorescence images under normal circumstance, and not restricted to be operated only in the dark room. In other words, the user is allowed to use the hand-held fluorescence microscope 200 to perform fluorescence detection without bring the hand-held fluorescence microscope 200 to the dark room in advance, thereby greatly improving the flexibility on selecting detection environment.

In practice, the light mask 285 and the housing 280 may be formed integrally. Alternatively, the light mask 285 may be detachably engaged in the front end of the housing 280.

As shown in FIG. 2, the second light beam L22 outputted from the hand-held fluorescence microscope 200 directly transmits to the specimen, and the light path of the second light beam L22 does not overlap with the light path of the fluorescence L23 from the specimen to the second filtering device 240. Accordingly, even a reflection light of the second light beam L22 is generated when the second light beam L22 shines on the specimen, but most of the reflection light does not mix in the light path of the fluorescence L23 to the second filtering device 240. As a result, optical noise received by the image sensor 250 can be reduced and thus the observation quality of the fluorescence images and detection accuracy can be improved.

Furthermore, since the dichroic mirror 130 of the traditional fluorescence microscope 100 is omitted in the hand-held fluorescence microscope 200, the hand-held fluorescence microscope 200 is more compact than the prior art. In addition, the volume of the first partial-spectrum light source 210 is much smaller than that of the traditional full-spectrum excitation light source 110. Accordingly, the first partial-spectrum light source 210, the first filtering device 220, the objective lens 230, the second filtering device 240, and the image sensor 250 of the hand-held fluorescence microscope 200 may be integrated inside the housing 280 without causing heat dissipation problems, thereby realizing miniaturization of the fluorescence microscope. In implementations, each of the above components may be fixedly disposed, movably disposed, or slidably disposed within the housing 280.

As a result, the user can easily carry the hand-held fluorescence microscope 200 to the place of the specimen. This not only increases the convenience of the detection, but also reduces the required transportation of the specimen. Thus, the risk of polluting the specimen during the transportation is effectively reduced.

In addition, since the traditional dichroic mirror 130 is not employed in the disclosed hand-held fluorescence microscope 200, there is more space for the objective lens 230 to move between the specimen and the image sensor 250. This increases the degree of freedom of zooming for the hand-held fluorescence microscope 200, so that the observation quality of the fluorescence images can be further improved.

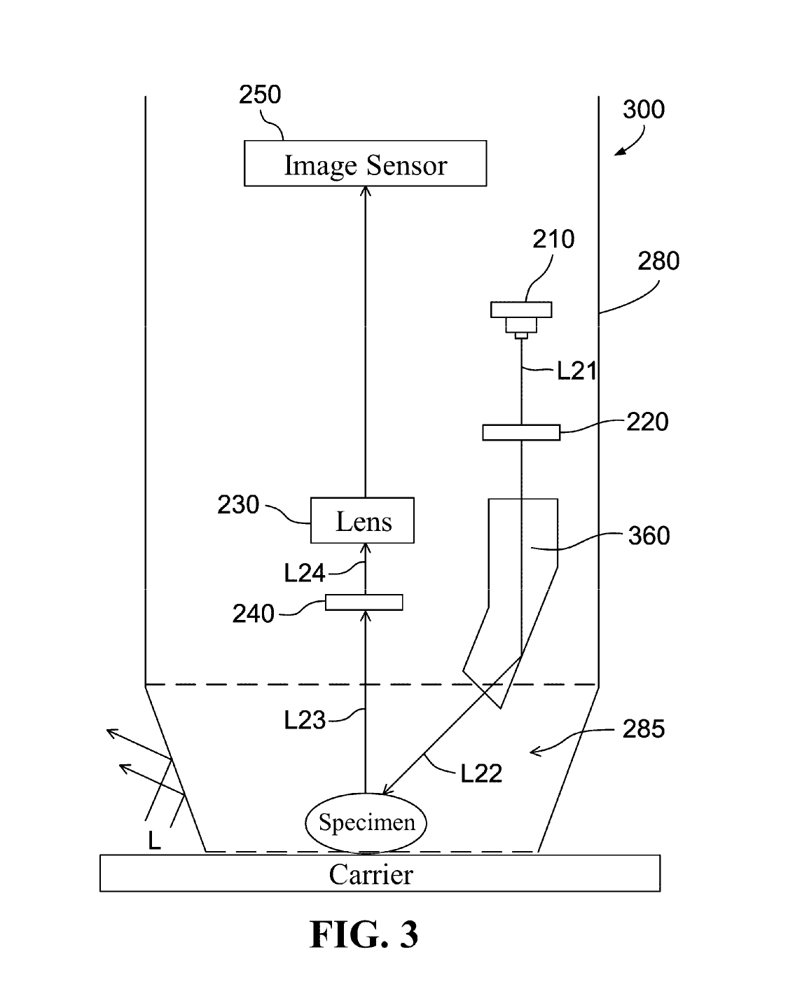

In the foregoing hand-held fluorescence microscope 200, the objective lens 230 is positioned on the light path between the specimen and the second filtering device 240, but this is merely an example, rather than a restriction on practical implementations. For example, in a hand-held fluorescence microscope 300 shown in FIG. 3, the objective lens 230 is positioned on the light path between the second filtering device 240 and image sensor 250.

Compared to the afore-mentioned hand-held fluorescence microscope 200, the hand-held fluorescence microscope 300 further comprises a light guide 360. In the embodiment of FIG. 3, the light guide 360 is positioned between the light output end of the first filtering device 220 and the specimen to reflect the second light beam L22 outputted from the first filtering device 220 to the specimen. The light guide 360 may be realized with a lens module, an optical fiber, a light guide plate, a light guide film, or any combination of the above components. The use of the light guide 360 allows the first partial-spectrum light source 210 and the first filtering device 220 to be positioned closer to the light path of the fluorescence L23 into the image sensor 250. As a result, the required width of the hand-held fluorescence microscope 300 can be further reduced to shrink the size and volume of the hand-held fluorescence microscope 300. In implementations, the light guide 360 may be instead positioned between the first partial-spectrum light source 210 and the first filtering device 220 to reflect the first light beam L21 outputted from the first partial-spectrum light source 210 to the first filtering device 220.

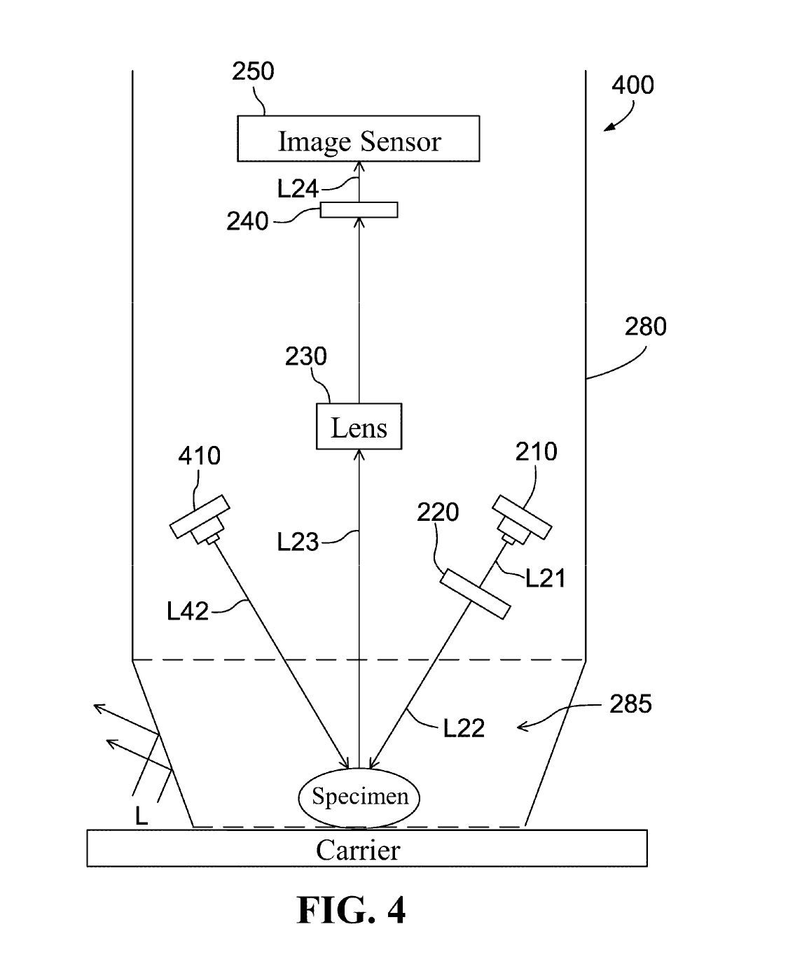

In other embodiments, the hand-held fluorescence microscope may be provided with multiple sets of light source to increase the operating convenience of the hand-held fluorescence microscope. For example, FIG. 4 is a simplified schematic diagram of a hand-held fluorescence microscope 400 in accordance with a third example embodiment. In the hand-held fluorescence microscope 400, an additional second partial-spectrum light source 410 is utilized for generating a fifth light beam L42 having a different light color from the first light beam L21. For example, in one embodiment, the first partial-spectrum light source 210 is realized with a green LED and the second partial-spectrum light source 410 is realized with a white LED. Accordingly, the first light beam L21 generated by the first partial-spectrum light source 210 is in green color and the fifth light beam L42 generated by the second partial-spectrum light source 410 is in white color.

The specimen image observed by the image sensor 250 when the second partial-spectrum light source 410 is used is different from that when the first partial-spectrum light source 210 is used. During the examination procedure, the user may activate a switch button (not shown in FIG. 4) positioned on the housing 280 to turn on the second partial-spectrum light source 410 (and simultaneously turn off the first partial-spectrum light source 210), and utilize the fifth light beam L42 generated by the second partial-spectrum light source 410 to observe the specimen. In this stage, the user may roughly locate the position of the portion to be detected within the specimen or align the hand-held fluorescence microscope 400 with the specimen. Then, the user may use the switch button to turn on the first partial-spectrum light source 210 (and simultaneously turn off the second partial-spectrum light source 410), and utilize the first light beam L21 generated by the first partial-spectrum light source 210 to perform fluorescence detection on the specimen. The above light source switching operation facilitates the user to quickly locate the portion to be detected and thus reduces the required detection time.

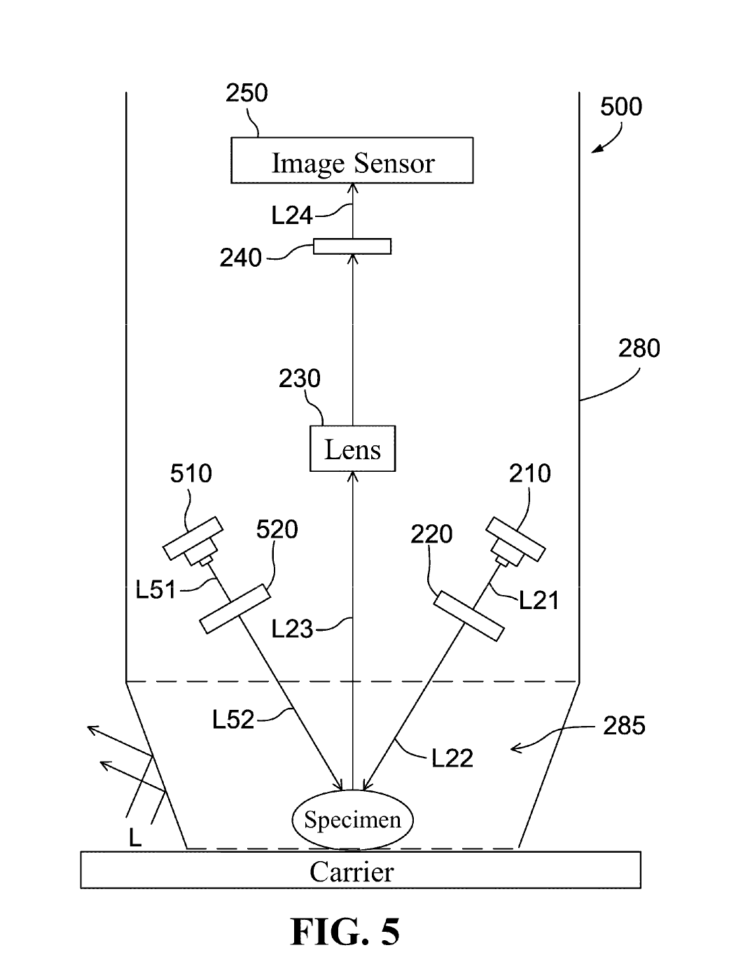

Please refer to FIG. 5, which shows a simplified schematic diagram of a hand-held fluorescence microscope 500 in accordance with a fourth example embodiment. In comparison with the hand-held fluorescence microscope 200, the hand-held fluorescence microscope 500 further comprises a second partial-spectrum light source 510 and a third filtering device 520. The second partial-spectrum light source 510 generates a sixth light beam L51, and the third filtering device 520 filters the sixth light beam L51 to output a seventh light beam L52. As shown in FIG. 5, the light path of the light L22 from the first filtering device 220 to the specimen does not overlap with the light path of the fluorescence L23 from the specimen to the second filtering device 240. In addition, the light path of the light L52 from the third filtering device 520 to the specimen does not overlap with the light path of the fluorescence L23 into the second filtering device 240.

Detecting of different specimen may require different fluorescent dye and different band of excitation light. In order to make a single hand-held fluorescence microscope 500 to be able to support more detection applications, the second partial-spectrum light source 510 and the first partial-spectrum light source 210 may be designed to have different output light colors. That is, the first light beam L21 generated by the first partial-spectrum light source 210 may have a light color different from that of the sixth light beam L51 generated by the second partial-spectrum light source 510, and the third filtering device 520 may have a filtering band different from that of the first filtering device 220. For example, the first partial-spectrum light source 210 may be a green light LED for generating green light, and the second partial-spectrum light source 510 may be a blue light LED for generating blue light. When the specimen requires the excitation light generated by the blue light LED, the user may activate a switch button (not shown in FIG. 5) positioned on the housing 280 to turn on the second partial-spectrum light source 510 (and simultaneously turn off the first partial-spectrum light source 210) to utilize the second partial-spectrum light source 510 to provide required excitation light. When the specimen requires the excitation light generated by the green light LED, the user may utilize the switch button to turn on the first partial-spectrum light source 210 (and simultaneously turn off the second partial-spectrum light source 510) to utilize the first partial-spectrum light source 210 to provide required excitation light. In other words, the hand-held fluorescence microscope 500 of this embodiment is a multi-function device and can be applied in different fluorescence detection applications. As a result, the detection entity no longer needs to purchase different fluorescence microscopes for different detection purposes, so the required hardware cost can be significantly reduced.

In another embodiment, the second partial-spectrum light source 510 and the first partial-spectrum light source 210 have the same output light color, and the third filtering device 520 has the same filtering band as the first filtering device 220. In this embodiment, the first partial-spectrum light source 210 and the second partial-spectrum light source 510 may be turn on simultaneously for increasing the density of excitation light outputted from the hand-held fluorescence microscope 500, thereby improving the image quality and detecting accuracy when detecting a specimen with weak fluorescence emission.

The image sensor 250 of the foregoing embodiments may transmits the generated image signals to a coupled computer or detection system via a transmission interface, such as a USB interface or a 1394 interface, and may receive required electricity for the components of the hand-held fluorescence microscope from the computer or detection system via the transmission interface. Accordingly, there is no need to arrange any battery device inside the disclosed hand-held fluorescence microscope. As a result, the volume and weight of the hand-held fluorescence microscope can be effectively reduced.

In addition, each of the filtering devices 220, 240, and 520 of the previous embodiments may be realized with a high-pass, low-pass, bandpass, or bandstop type absorptive filtering device or reflective filtering device. Additionally, each filtering device may be combined with other components. For example, the second filtering device 240 and the objective lens 230 may be integrated into a single component by forming the second filtering device 240 on the objective lens 230. Similarly, the second filtering device 240 may be directly positioned on the light receiving end of the image sensor 250. The filtering device 220 or 520 may be directly coated onto the partial-spectrum light source 210 or 510.

As can be seen from the foregoing descriptions, the light path of the light outputted from the hand-held fluorescence microscope in each of the previous embodiments does not overlap with the light path of the fluorescence from the specimen to the second filtering device 240. Thus, at least most of the reflection light of light beam outputted from the hand-held fluorescence microscope 200 does not mix in the light path of the fluorescence to the second filtering device 240. As a result, optical noise received by the image sensor 250 can be reduced, thereby improving the observation quality of the fluorescence images and accuracy of the fluorescence detection.

Furthermore, there is no need to add the traditional dichroic mirror in the disclosed hand-held fluorescence microscope. This not only simplifies the structure and reduces the volume of the disclosed hand-held fluorescence microscope, but also increases the movable range of the objective lens 230 between the specimen and the image sensor 250. As a result, the degree of freedom of zooming for the disclosed hand-held fluorescence microscope is increased, thereby improving the observation quality of the fluorescence images.

Since the partial-spectrum light sources 210, 410, and 510 are realized by light source components of smaller size, such as LED or LD, and the structure of the disclosed hand-held fluorescence microscope is improved as describe above, the disclosed hand-held fluorescence microscope is more compact in size and more convenient to carry, and can be applied in more detection environments.

Moreover, since the light mask 285 is capable of blocking most ambient light, the interference in the fluorescence detection caused by the ambient light can be effective reduced. Accordingly, the user is allowed to conducting fluorescence detection without the need to carry the specimen and the disclosed hand-held fluorescence microscope to the dark room in advance. This greatly increases the flexibility on selecting the place for conducting the fluorescence detection, and is thus very beneficial for promoting the applications of fluorescence detection.

Certain terms are used throughout the description and following claims to refer to particular components. As one skilled in the art will appreciate, a component may be referred by different names. This document does not intend to distinguish between components that differ in name but not in function. In the following description and in the claims, the term “comprise” is used in an open-ended fashion, and thus should be interpreted to mean “include, but not limited to . . . ” Also, the phrase “coupled with” is intended to compass any indirect or direct connection. Accordingly, if this document mentioned that a first device is coupled with a second device, it means that the first device may be directly or indirectly connected to the second device through electrical connections, wireless communications, optical communications, or other signal connections with/without other intermediate devices or connection means.

The quantities, positions, and connections of components shown or described in the specification and accompanying drawings are merely exemplary examples for simplifying the descriptions. Each component mentioned in the specification may be implemented with one or more components, and the functions of different components may be integrated in a single component. In addition, as can be appreciated by those skilled in the art, if this document mentioned that some values, such as wavelengths, frequencies, or time, are the same, it encompasses the case where those values have some slight difference due to the manufacturing technology, design error, or equipment conditions.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A hand-held fluorescence microscope comprising:
a housing;
a first partial-spectrum light source, arranged inside the housing, for generating a first light beam;
a first filtering device, arranged inside the housing, for filtering the first light beam to provide a second light beam;
a second filtering device, arranged inside the housing, for filtering a fluorescence to provide a fourth light beam, wherein the fluorescence is generated by a specimen when exposed to the second light beam;
an image sensor, arranged inside the housing, for receiving the fourth light beam to generate fluorescence images; and
a light mask, arranged in one end of the housing, for surrounding the specimen to reduce or avoid external light from being entering the image sensor;
wherein a light path of the second light beam projecting to the specimen does not overlap with a light path of the fluorescence radiating from the specimen to the second filtering device, and there is no dichroic mirror positioned on either a light path of the fluorescence into the second filtering device or a light path of the fourth light beam into the image sensor.

2. The hand-held fluorescence microscope of claim 1, further comprising:
an objective lens positioned between the specimen and the second filtering device, or between the second filtering device and the image sensor.

3. The hand-held fluorescence microscope of claim 2, wherein the first partial-spectrum light source is one or more light emitting diodes or laser diodes.

4. The hand-held fluorescence microscope of claim 3, wherein the image sensor receives required electricity from a computer or a detection system.

5. The hand-held fluorescence microscope of claim 4, further comprising:
a light guide, positioned between a light output terminal of the first filtering device and the specimen, for reflecting the second light beam to the specimen.

6. The hand-held fluorescence microscope of claim 4, further comprising:
a light guide, positioned between the first partial-spectrum light source and the first filtering device, for reflecting the first light beam to the first filtering device.

7. A hand-held fluorescence microscope comprising:
a housing;
a first partial-spectrum light source, arranged inside the housing, for generating a first light beam;
a first filtering device, arranged inside the housing, for filtering the first light beam to provide a second light beam;
a second filtering device, arranged inside the housing, for filtering a fluorescence to provide a fourth light beam, wherein the fluorescence is generated by a specimen when exposed to the second light beam;
a second partial-spectrum light source, arranged inside the housing, for generating a fifth light beam to shine on the specimen, wherein the fifth light beam and the first light beam have different light colors, the first partial-spectrum light source is turn off when the second partial-spectrum light source is turn on, and the second partial-spectrum light source is turn off when the first partial-spectrum light source is turn on;
an image sensor, arranged inside the housing, for receiving the fourth light beam to generate a fluorescence image; and
a light mask, arranged in one end of the housing, for surrounding the specimen to reduce or avoid external light from being entering the image sensor;
wherein a light path of the second light beam projecting to the specimen does not overlap with a light path of the fluorescence radiating from the specimen to the second filtering device, and there is no dichroic mirror positioned on either a light path of the fluorescence into the second filtering device or a light path of the fourth light beam into the image sensor.

8. The hand-held fluorescence microscope of claim 7, further comprising:
an objective lens positioned between the specimen and the second filtering device, or between the second filtering device and the image sensor;
wherein the first partial-spectrum light source is one or more light emitting diodes or laser diodes.

9. A hand-held fluorescence microscope comprising:
a housing;
a first partial-spectrum light source, arranged inside the housing, for generating a first light beam;
a first filtering device, arranged inside the housing, for filtering the first light beam to provide a second light beam;
a second filtering device, arranged inside the housing, for filtering a fluorescence to provide a fourth light beam, wherein the fluorescence is generated by a specimen when exposed to the second light beam;
a second partial-spectrum light source, arranged inside the housing, for generating a sixth light beam, wherein the sixth light beam and the first light beam have different light colors, the first partial-spectrum light source is turn off when the second partial-spectrum light source is turn on, and the second partial-spectrum light source is turn off when the first partial-spectrum light source is turn on;
a third filtering device, arranged inside the housing, for filtering the sixth light beam to provide a seventh light beam;
an image sensor, arranged inside the housing, for receiving the fourth light beam to generate a fluorescence image; and
a light mask, arranged in one end of the housing, for surrounding the specimen to reduce or avoid external light from being entering the image sensor;
wherein a light path of the fluorescence radiating from the specimen to the second filtering device does not overlap with either a light path of the second light beam projecting to the specimen or a light path of the seventh light beam projecting to the specimen, and there is no dichroic mirror positioned on either a light path of the fluorescence into the second filtering device or a light path of the fourth light beam into the image sensor.

10. The hand-held fluorescence microscope of claim 9, further comprising:
an objective lens positioned between the specimen and the second filtering device, or between the second filtering device and the image sensor;
wherein the first partial-spectrum light source is one or more light emitting diodes or laser diodes.
